(19) United States
(12) Patent Application Publication
(10) Pub. No.: US 2026/0121845 A1
(43) Pub. Date: Apr. 30, 2026

(54) PROTECTION AND ENCRYPTION OF OBJECTS, METADATA, AND ENCRYPTION KEYS

(71) Applicant: Tigris Data, Inc., Sunnyvale, CA (US)

(72) Inventors: Jigar JOSHI, Pleasanton, CA (US); Ovais TARIQ, Mountain View, CA (US)

(21) Appl. No.: 19/003,744

(22) Filed: Dec. 27, 2024

Related U.S. Application Data
(60) Provisional application No. 63/617,320, filed on Jan. 3, 2024.

(51) Int. Cl. H04L 9/08; H04L 9/14

(52) U.S. Cl. CPC H04L 9/0863; H04L 9/0894; H04L 9/14

(57) ABSTRACT

A computer implemented method for securely storing data on an object store, comprising: receiving a passphrase and an object at a computing device, wherein metadata is associated with the object; generating a first encryption key based on the passphrase; encrypting the metadata using a second encryption key; encrypting the object using a third encryption key; encrypting the third encryption key using the first encryption key; providing the encrypted object, the encrypted metadata, and the encrypted third encryption key to a processing device for storing in the object store.

### CROSS REFERENCE

This application claims the benefit of U.S. Provisional Application No. 63/617,320, filed Jan. 3, 2024, which is incorporated herein by reference in its entirety.

### SUMMARY

Provided herein are methods and systems for secure storage for objects and metadata of objects.

In one aspect, the embodiments herein disclose a method for securely storing data on an object store, comprising: receiving a passphrase and an object at a computing device, wherein metadata is associated with the object; generating a first encryption key based on the passphrase; encrypting the metadata using a second encryption key; encrypting the object using a third encryption key; encrypting the third encryption key using the first encryption key; providing the encrypted object, the encrypted metadata, and the encrypted third encryption key to a processing device for storing in the object store. In some embodiments, the first encryption key is a master key. In some embodiments, one or more of the first encryption key, the second encryption key, or the third encryption key is a high entropy key. In some embodiments, the master key is derived from the passphrase and a client-side generated key. In some embodiments, the method further comprises generating the second encryption key. In some embodiments, one or more of the first encryption key, the second encryption key, or the third encryption key is a 256-bit secure random key. In some embodiments, the first encryption key and the second encryption key are generated using a passphrase based key derivation function2. In some embodiments, the metadata comprises an object identifier. In some embodiments, the metadata comprises a type of content of the object, a size of the object, a date of creation of the object, an entity associated with the object, or a name of the object. In some embodiments, the object store utilizes cloud computing. In some embodiments, receiving the passphrase and the object comprises receiving the passphrase and the object via user input. In some embodiments, storing the encrypted object, the encrypted metadata, and the encrypted third encryption key in the object store comprises providing the encrypted object, the encrypted metadata, and the encrypted third encryption key via a distributed stateless gateway service. In some embodiments, the metadata is stored on distributed solid-state drives. In some embodiments, the method further comprises storing the first encryption key and second encryption key on the computing device. In some embodiments, the computing device is configured to: decrypt the third encryption key using the first encryption key; and decrypt the object using the third encryption key. In some embodiments, the computing device is configured to: decrypt the metadata using the second encryption key. In some embodiments, a plurality of objects comprising the object are stored in one or more buckets in the object store. In some embodiments, the method further comprises providing a request for one or more of the object and the metadata. In some embodiments, the method further comprises receiving the encrypted object and the encrypted third encryption key in response to the request; decrypting the third encryption key using the first encryption key; and decrypting the object using the third encryption key. In some embodiments, the method further comprises receiving the encrypted metadata in response to the request; and decrypting the metadata using the second encryption key.

In one aspect, the embodiments herein disclose a method for retrieving data from a storage device, comprising: providing a request for one or more of an object or metadata describing the object to a processing device; receiving one or more of an object, a first encryption key, or the metadata from the processing device, wherein: the received one or more of an object, the first encryption key or the metadata are encrypted, and the received one or more of the encrypted object and the encrypted metadata is retrieved by the processing device; and decrypting the one or more of an object, the first encryption key, or the metadata based on one or more other encryption keys. In some embodiments, the one or more of the object or the metadata comprises the object, and the one or more other encryption keys comprises a master key. In some embodiments, the master key is a high entropy key. In some embodiments, decrypting the one or more of the object, the first encryption key, or the metadata based on the one or more other encryption keys comprises: decrypting the encrypted encryption key using one of the one or more other encryption keys, thereby creating a decrypted encryption key; and decrypting the object using the decrypted encryption key. In some embodiments, the master key is derived from the passphrase and a client-side generated key. In some embodiments, the one or more of the object, the first encryption key, or the metadata comprises the metadata, and the one or more other encryption keys comprises an identification key. In some embodiments, the method further comprises encrypting one or more portions of the request using the identification key. In some embodiments, at least one of the one or more other encryption keys is generated using a passphrase based key derivation function2. In some embodiments, the one or more of the object, the first encryption key, or the metadata is retrieved from an object store. In some embodiments, the object store utilizes cloud computing. In some embodiments, the metadata is stored on distributed solid-state drives. In some embodiments, the method further comprises decrypting the metadata using the identification key. In some embodiments, a plurality of objects comprising the object are stored in one or more buckets in the object store.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents and patent applications incorporated by reference contradict the disclosure contained in the specification, the specification is intended to supersede and/or take precedence over any such contradictory material.

### BRIEF DESCRIPTION OF THE DRAWINGS

The novel features of the inventive concepts are set forth with particularity in the appended claims. A better understanding of the features and advantages of the present inventive concepts will be obtained by reference to the following detailed description that sets forth illustrative embodiments, in which the principles of the inventive concepts are utilized, and the accompanying drawings (also “Figure” and “FIG.” herein), of which:

FIG. 1 shows a non-limiting example of a system for encrypting, de-encrypting, and/or transmitting objects, metadata, and encryption keys.

FIG. 2 shows a non-limiting example of a process for encrypting, de-encrypting, and/or transmitting objects, metadata, and encryption keys.

FIG. 3 shows a non-limiting example of the method disclosed herein for securely storing objects, metadata, and/or encryption keys.

FIG. 4 shows a non-limiting example of the method disclosed herein for retrieving objects, metadata, and/or encryption keys.

FIG. 5 shows a non-limiting example of a computing device with one or more processors, memory, storage, and a network interface.

FIG. 6 shows a non-limiting example of a web/mobile application provision system providing browser-based and/or native mobile user interfaces.

FIG. 7 shows a non-limiting example of a cloud-based web/mobile application provision system comprising an elastically load balanced, auto-scaling web server and application server resources as well synchronously replicated databases.

### DETAILED DESCRIPTION

As the aspects of daily life become more and more computerized, the need for securely storing information is paramount. Conventional methods may leave a user's information prone to hacking or even mistaken delivery, which can leave the user's information in the wrong hands. Accordingly, there is a need in the art to more securely store information.

The systems and method described herein overcome the needs of conventional methods by employing additional layers of protection to stored data, such as objects and the metadata of those objects. The additional layers may include encrypting not only the data, but also the encryption keys that could decrypt the data. Accordingly, the extra layers of encryption ensure that the data is not accessed by anybody but the original owner of the data.

For example, by creating multiple encryption keys for the object and the metadata of the object, and only providing encrypted objects, encrypted metadata, and encrypted encryption keys, while retaining the encryption keys that have not been encrypted, a user can more securely store their data by ensuring that, even if the data is placed into the wrong hands, the recipient will not be able to access the data. An object itself may have its data encrypted by an encryption key, and the metadata could also be encrypted by a separate encryption key, and be provided to be stored in an object store. However, even further, the encryption key used to encrypt the object could be encrypted as well by another encryption key (e.g., a “master” key as referred to below), and the encrypted encryption key may be stored in the object store as well.

Thus, even if an initial layer of security was breached, and the object and its metadata were accessed, the object and its metadata would not be able to be decrypted. If a second layer of security was breached, and the encryption key used to decrypt the object were accessed, the object and its metadata would not be able to be decrypted because the encryption key used to decrypt the object would also be encrypted, while the encryption key used to decrypt the encryption key and the identification key used to decrypt metadata would not be stored in the object store. Accordingly, even if the security of the object store is breached and the encrypted object, encrypted metadata, and encrypted encryption key are obtained, there would be no way to decrypt them.

Instead, the “master” key and the separate encryption key used to decrypt the metadata would be safely stored on the device of the user, and, in some embodiments described herein, any requests to retrieve the data can be at least partially encrypted by the separate encryption key. Once the encrypted object and the encrypted encryption key are received, the master key can decrypt the encrypted encryption key, which can then be used to decrypt the object, and the separate encryption key can be used to decrypt the metadata.

Thus, the systems and methods described herein add extra layers of security for storage of objects and their metadata including at least one object identifier by not only encrypting the objects and the metadata, but also encrypting encryption keys used to decrypt the objects, while safely storing the encryption keys that would be used to decrypt the encrypted encryption key and the metadata on the device of a user. Accordingly, in the event that the encrypted object, the encrypted metadata, or even the encrypted encryption key was received by an improper recipient, the data could still not be decrypted except by the original user.

### Systems

Disclosed herein are embodiments for systems of secure storage of data through encryption and decryption. The data as described herein may include objects, metadata, and encryption keys. In some embodiments, an object may include an image, video, a document (e.g., pdf, word doc, JSON document, etc.), application logs, application states, backups, machine learning models, or any random data. While some objects are listed above, these objects are exemplary and other types of objects may be used. In some embodiments, objects comprise data (e.g., content), metadata (e.g., a set of key-value pairs associated with the object such as a name of the object, a creation date of the object, a content type of the object, a size of the object, or any other custom attributes or tags of the object), and/or an object identifier (e.g., a unique identifier or key that distinguishes it from other objects).

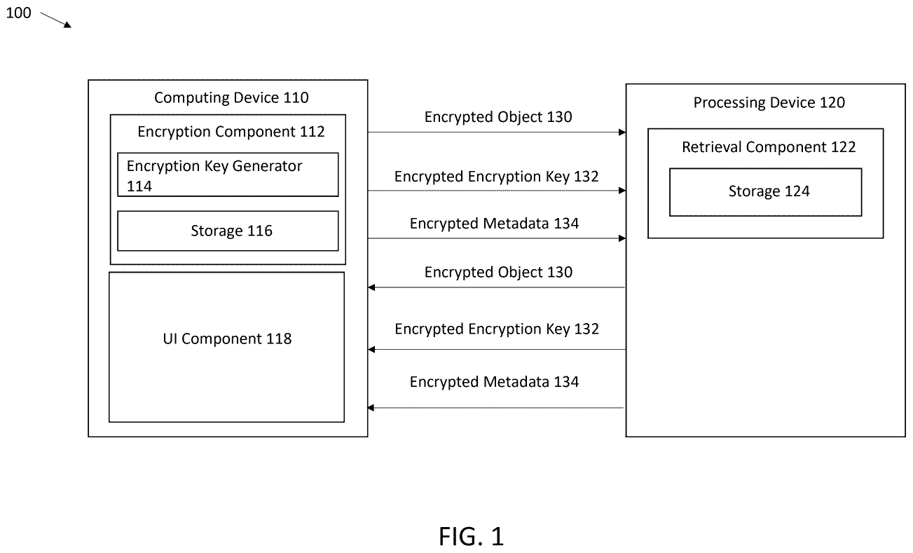

FIG. 1 depicts a non-limiting example of a computing system 100 for securely storing data. In this depicted example, system 100 includes computing device 110 and processing device 120. In some embodiments, the processing device may be a server. In some embodiments, one or both of computing device 110 and processing device 120 may be configured to communicate with a network. In some embodiments, the server may comprise an object store.

In this depicted example, computing device 110 includes encryption component 112 and user interface (UI) component 118, and is configured to communicate with processing device 120. In this depicted embodiment, encryption component 112 includes encryption key generator 114 and storage 116. In some embodiments, encryption component 112 may not include storage 116, and may use another device for storage.

In this depicted embodiment, encryption component 112 is configured to generate one or more encryption keys. In some embodiments, the one or more encryption keys may include a first type of encryption key, a second type of encryption key, and/or a third type of encryption key. The first type of encryption key, second type of encryption key, and/or third type encryption key may include a “master” key, an “identification” key, and/or a “data key”. The one or more encryption keys may be used to encrypt or decrypt data. The data may include objects, metadata, encryption keys, or other types of data. In some embodiments, an encryption key may be configured to encrypt or decrypt a single type of data. In some embodiments, an encryption key may be configured to encrypt or decrypt a plurality of types of data.

In some embodiments, the first type of encryption key may include one or more master keys. In some embodiments, a master key may be used to encrypt one or more other encryption keys. In some embodiments, the other encryption keys include data keys. Similarly, in some embodiments, a master key may be used to decrypt one or more of the other encryption keys that were encrypted. In some embodiments, a master key may be generated based on user input. In some embodiments, the user input may be received at a user interface of UI component 118. In some embodiments, the user input may comprise a passphrase. In some embodiments, the passphrase may comprise one or more of a text string, an image, or other user input. In some embodiments, generating the master key may be based on individual components of the passphrase. For example, if a passphrase of “533668” is received as user input, the encryption component 112 may generate a master key of “ifIchjm105gD31UMRtEv5sH43IGSVJ6SkXxqhTQ6yh8” based on the passphrase. In that particular example, the master key includes each individual character of the text string. In other examples, the master key may not include each individual character of the text string. In some embodiments, the master key is derived from a client-side generated key as well as the passphrase.

In some embodiments, the second type of encryption key may include one or more identification keys. The identification key may be associated with the metadata of an object. For example, metadata of an object may include one or more object identifiers for identifying the object. In some embodiments, an object identifier of the one or more object identifiers may comprise an aspect of metadata (e.g., comprises a type of content of the object, a size of the object, a date of creation of the object, an entity associated with the object, or a name of the object) that may help identify the object. In some embodiments, the location of an object may indicate a bucket that the object is contained in. A bucket may be a container of objects, where a user associated with computing device 110 may provide user input that may be used to generate one or more buckets for objects to be placed in. In some embodiments, an object identifier of the one or more object identifiers comprises a location of the object and another aspect of the object. In those embodiments, the object identifier comprising the location of the object and another aspect of the object is unique to the object. Accordingly, identification key may be used to encrypt one or more object identifiers of an object, such as the name of the object and a bucket the object is placed in. Similarly, the identification key may be used to de-encrypt the one or more object identifiers of the metadata. In some embodiments, the identification key can be generated based on the passphrase using the same process or a similar process used to generate the master key.

In some embodiments, the third type of encryption key may include one or more data keys. The data key may be used to encrypt the content of an object. Similarly, the data key may be used to decrypt the content of an object that was encrypted. In some embodiments, a distinct data key may be generated for each object that is encrypted (e.g., each object may be encrypted by a distinct corresponding data key). In some embodiments, one data key may be generated for each object that is encrypted (e.g., each object may be encrypted by the same data key).

In some embodiments, one or more encryption keys may be generated using a Key Derivative Function (KDF). In some embodiments, the KDF may be a password based key derivative function2 (referred to hereinafter as “PBKDF2”). In some embodiments, one or more encryption keys are high entropy keys. In some embodiments, one or more encryption keys are 256-bit secure random keys.

In this depicted embodiment, storage 116 may be used to store one or more encryption keys, objects, and/or metadata. In some embodiments, one or more encryption keys, objects, and/or metadata may be retrieved from storage 116 for use.

In this depicted embodiment, processing device 120 further includes retrieval component 122. Further, in this depicted embodiment, retrieval component 122 includes storage 124. Retrieval component 122 may be configured to retrieve one or more encryption keys (e.g., encrypted or decrypted encryption keys). Storage 124 may be configured to store one or more encryption keys (e.g., encrypted or decrypted encryption keys), one or more objects (e.g., encrypted or decrypted objects), and/or metadata (e.g., encrypted or decrypted metadata).

The computing device 110 and processing device 120 may be configured to communicate in order to securely store one or more encryption keys, one or more objects, and one or more metadata. As described above, a master key may be used to encrypt one or more encryption keys or decrypt an encrypted encryption key, an identification key may be used to encrypt metadata of an object or decrypt the encrypted metadata of an object, and a data key may be used to encrypt an object itself.

Accordingly, the keys as described above may be used to securely store one or more objects or metadata of the one or more objects. For example, as shown in this depicted embodiment, for an object 130, the computing device may use encryption component 112 to encrypt the object 130 using a data key, encrypt a data key 132 using a master key, and/or encrypt metadata 134 of the object. As depicted in this embodiment, computing device 110 may be configured to provide the encrypted object 130, the encrypted data key 132, and/or encrypted metadata 134 to the processing device 120, which may store the encrypted object 130, the encrypted data key 132, and/or encrypted metadata 134. The processing device 120 may then be configured to prove the encrypted object 130, the encrypted data key 132, and/or encrypted metadata 134 back to the computing device 110 when requested. Upon receiving the encrypted object 130, the encrypted data key 132, and/or encrypted metadata 134, the computing device 110 may be configured to decrypt the encrypted data key 132 using the master key, decrypt the object 130 using the decrypted data key 132, and decrypt the encrypted metadata 134 using the identification key. In some embodiments, the request may be at least in part for the metadata, and one or more portions of the request may be encrypted by the identification key.

As described above, a data key may be generated for each object, allowing for secure storage of each object. In some embodiments, each data key may be encrypted by the master key. In some embodiments, the computing device 110 generates only one master key to encrypt data keys. In some embodiments, the computing device 110 may generate a plurality of master keys to encrypt data keys. In some embodiments, the computing device 110 generates only one identification key to encrypt metadata of objects. In some embodiments, the computing device 110 may generate a plurality of identification keys to encrypt metadata of objects.

Thus, as described herein, the system accounts for more secure storage of objects by encrypting encryption keys that may be used to decrypt the objects, while allowing the computing device 110 to retain to the encryption key that would allow for the decryption of the encryption key that may be used to decrypt objects. Accordingly, the ability to decrypt the objects, as well as the ability to decrypt the metadata of the objects, remains with the computing device 110 with the master key and the identification key, respectively, and thus provides an extra layer of security.

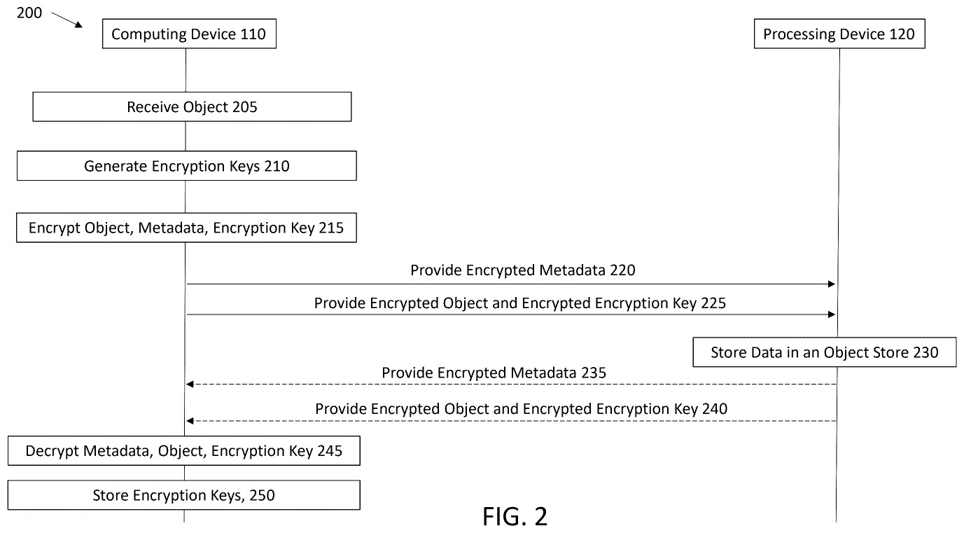

FIG. 2 depicts an example process 200 for securely storing one or more objects. In this depicted embodiment, computing device 110 and processing device 120 may be in communication. In some embodiments, computing device 110 and/or processing device 120 may be in communication with a network. In some embodiments, the processing device 120 may comprise an object store.

At step 205, the computing device 110 may receive an object. The object may be received as or may be indicated with user input. In some embodiments, the user input may be received via a user interface.

The computing device 110 may then generate one or more encryption keys at step 210. In some embodiments, a data key is generated for encrypting the object. In some embodiments, a master key and/or an identification key are generated in addition to the data key. In some embodiments, the master key and/or the identification key may be generated based on a passphrase as described with respect to FIG. 1. The master key may be derived from both the passphrase and a client side generated key. The object may be received as or may be indicated with user input. In some embodiments, the user input may be received via a user interface. In some embodiments, the user input may comprise a text string.

The computing device 110 may then encrypt (1) the object (e.g., using the data key) and the data key (e.g., using the master key), (2) the metadata (e.g., using the identification key), or (3) the object (e.g., using the data key), the data key (e.g., using the master key), and the metadata (e.g., using the identification key) at step 215.

Accordingly, if the computing device 110 encrypted the object and the data key, the computing device provides the encrypted object and the encrypted data key to the processing device for storage at step 220. If the computing device 110 encrypted the metadata the computing device provides the encrypted metadata to the processing device for storage at step 225. If the computing device 110 encrypted the object, the data key, and the metadata, the computing device 110 performs both step 220 and step 225.

The processing device 110 may store the received encrypted object, received encrypted data key, and received encrypted metadata in an object store at step 230.

When computing device 110 provides a request for the encrypted object, encrypted data key, and/or encrypted metadata, the processing device 120 may retrieve the received encrypted object, encrypted data key, and/or encrypted metadata from the object store and provide the encrypted object, encrypted data key, and encrypted metadata at steps 235 and 240. In some embodiments, the request may be at least in part for the metadata, and one or more portions of the request may be encrypted by the identification key.

Upon receiving the encrypted object, encrypted data key, and/or encrypted metadata from the processing device 120, the computing device 110 may then decrypt the data key using the master key, decrypt the object using the decrypted data key, and decrypt the metadata using the identification key.

### Example Method for Securely Storing Objects and Their Metadata

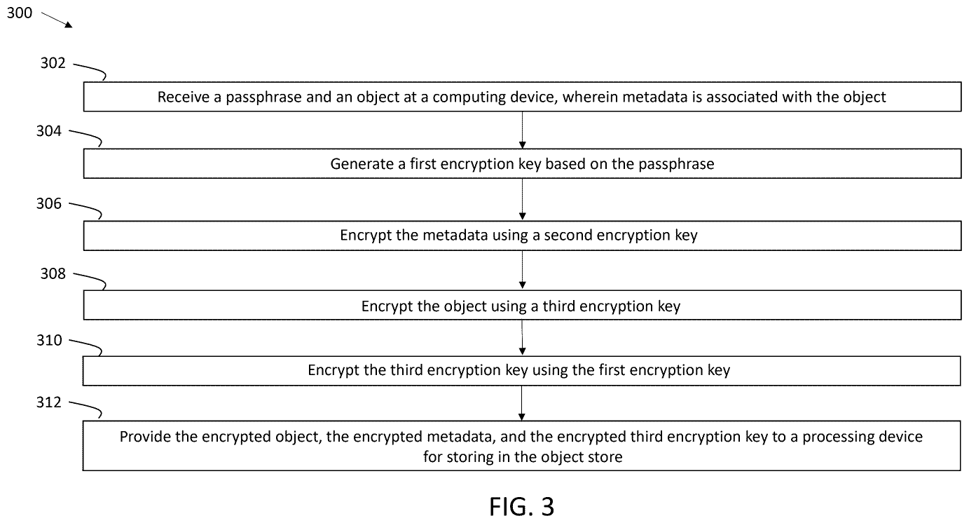

FIG. 3 depicts an example method 300 for securely storing data on an object store. In some embodiments, the method 300 may include utilizing one or more devices (e.g., the computing device 110 and processing device 120 of FIGS. 1-2).

The method begins at step 302 with receiving a passphrase and an object at a computing device. In some embodiments, metadata may be associated with the object. In some embodiments, the passphrase may be received as user input. In some embodiments, the user input may be received through a user interface of the computing device.

At step 304, a first encryption key is generated based on the passphrase. In some embodiments, the first encryption key is a master key as described with respect to FIGS. 1-2. In some embodiments, the master key being generated based on the passphrase may include generating the master key using a KDF. In some embodiments, the KDF may be a PBKDF2. In some embodiments, the first encryption key may be a high entropy key. In some embodiments, the first encryption key may be a 256-bit secure random key. In some embodiments, the first encryption key may be used to encrypt one or more encryption keys or decrypt one or more encrypted encryption keys.

At step 306, the metadata of the object is encrypted using a second encryption key. In some embodiments, the computing device generates the second encryption key. In some embodiments, the second encryption key is an identification key. In some embodiments, encrypting the metadata of the object includes encrypting one or more object identifiers of the metadata of the object as described with respect to FIG. 1. In some embodiments, the location of the object may indicate a bucket that the object is contained in. In some embodiments, the identification key is generated based on the passphrase. In some embodiments, the identification key being generated based on the passphrase may include generating the identification key using a KDF. In some embodiments, the KDF may be a PBKDF2. In some embodiments, the second encryption key may be a high entropy key. In some embodiments, the second encryption key may be a 256-bit secure random key.

At step 308, the object is encrypted using a third encryption key. In some embodiments, the computing device generates the third encryption key. In some embodiments, the third encryption key is a data key. In some embodiments, a plurality of objects may be received, and a data key may be generated for each object that is received. In some embodiments, the third encryption key may be a high entropy key. In some embodiments, the third encryption key may be a 256-bit secure random key.

At step 310, the third encryption key is encrypted using the first encryption key.

At step 312, one or more of the encrypted object, the encrypted metadata, and the encrypted third encryption key are provided for storage in an object store. In some embodiments, the object store is on a processing device. In some embodiments, the object store may utilize cloud computing. In some embodiments, the encrypted object, the encrypted metadata, and/or the encrypted third encryption key may be retrieved from the cloud store based on a received request. In some embodiments, the encrypted object, the encrypted metadata, and/or the encrypted third encryption key may be decrypted using the third encryption key, the second encryption key, or the first encryption key, respectively. In some embodiments, the object store may include a plurality of objects that are stored in one or more buckets on the object store. In some embodiments, the encrypted object may be stored in a bucket of the one or more buckets. In some embodiments, the first encryption key and the second encryption key may be stored on the computing device. In some embodiments, the metadata may be stored on a distributed solid-state drive. In some embodiments, the encrypted object, the encrypted metadata, and the encrypted third encryption key are provided to the object store via a distributed stateless gateway service.

### Example Method for Retrieving Objects and Their Metadata

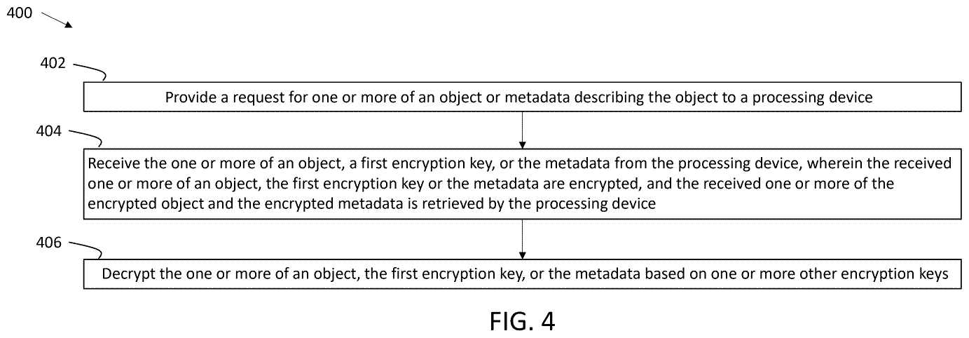

FIG. 4 depicts an example method 400 for retrieving data (e.g., one or more objects) from a storage device. In some embodiments, one or more devices (e.g., computing device 110 and processing device 120 of FIGS. 1-2) may be utilized. In some embodiments, an object store may be utilized.

At step 402, a request for one or more of an object or metadata describing the object is provided. In some embodiments, the request is provided to a processing device.

At step 404, the one or more of the object, the metadata, and an encryption key are received. The one or more of the object, the metadata, and the encryption key may be encrypted. In some embodiments, the encryption key may be configured to decrypt the encrypted object once the encrypted encryption key is decrypted. The encryption key may be a data key as described with respect to FIGS. 1-2.

At step 406, the one or more of the object, the metadata, and the encryption key are decrypted using one or more other encryption keys. In some embodiments, the one or more other encryption keys include a master key and/or an identification key. In some embodiments, the master key and/or the identification key may have been generated according to FIGS. 1-3. In some embodiments, the master key may be used to decrypt the encrypted encryption key. In some embodiments, the decrypted encryption key may be used to then decrypt the object. In some embodiments, the identification key may be used to decrypt the metadata. In some embodiments, the metadata may include one or more object identifiers (e.g., object identifiers as described with respect to FIG. 1). In some embodiments, the request may be at least in part for the metadata, and one or more portions of the request may be encrypted by the identification key.

In some embodiments, objects (encrypted or decrypted), metadata (encrypted or decrypted) of the objects, and encrypted encryption keys may be stored on an object store. In some embodiments, the objects (encrypted or decrypted), metadata (encrypted or decrypted) of the objects, and encrypted encryption keys may be retrieved based on the request. In some embodiments, the object store utilizes cloud computing. In some embodiments, the metadata is stored on distributed solid state drives.

In some embodiments, the one or more of the object, the metadata of the object, and the encryption key (e.g., the data key) includes the encrypted object and the encrypted encryption key. In those embodiments, the method may further comprise a step for decrypting the encrypted encryption key. In those embodiments where the encrypted encryption key is decrypted, the method may further comprise a step for decrypting the object using the decrypted encryption key. In some embodiments, after the object is decrypted, the content of the object may be displayed. In some embodiments, the content of the object may be displayed on a user interface.

In some embodiments, the one or more of the object, the metadata of the object, and the encryption key (e.g., the data key) includes the encrypted metadata. In those embodiments, the method may further comprise a step for decrypting the encrypted metadata using the identification key. In some embodiments, the decrypted metadata may be displayed on a user interface.

In some embodiments, the one or more of the object, the metadata of the object, and the encryption key (e.g., the data key) includes the encrypted object, the encrypted encryption key, and the encrypted metadata. In those embodiments, the method may further comprise a step for decrypting the encrypted metadata using the identification key. In those embodiments, the method may further comprise a step for decrypting the encrypted encryption key. In those embodiments where the encrypted encryption key is decrypted, the method may further comprise a step for decrypting the object using the decrypted encryption key. In some embodiments, after the object is decrypted, the content of the object may be displayed. In some embodiments, the content of the object and/or the metadata of the objected is displayed on a user interface.

Accordingly, through the systems and methods described herein, objects and their associated metadata may be more securely stored. Object and metadata may, in some cases, be wrongly requested or wrongly retrieved, which can lead to the object and metadata ending up in the wrong hands. With the systems and methods described herein, the object and metadata are both encrypted and stored, adding an extra layer of security to their storage. Even further, the metadata cannot be decrypted without the identification key, meaning that only users who encrypted the metadata can decrypt it as well. Accordingly, if the metadata is mistakenly provided elsewhere, the metadata will still not be able to be access. Similarly, the object cannot be decrypted without the data key that encrypted the object, and the data key that encrypted the object cannot be used to decrypt the object without first being decrypted by the master key, which is in the possession of the user who provided the object for storage. Accordingly, users can feel safer in securing their objects through the added layers of security provided by the encrypted objects, encrypted metadata, and encrypted data key(s) in combination with the master key and the identification key.

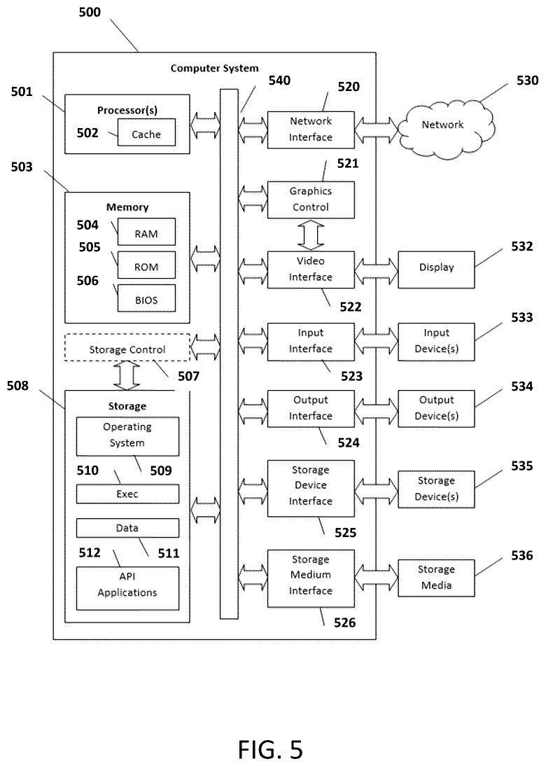

Referring to FIG. 5, a block diagram is shown depicting an exemplary machine that includes a computer system 500 (e.g., a processing or computing system) within which a set of instructions can execute for causing a device to perform or execute any one or more of the aspects and/or methodologies for static code scheduling of the present disclosure. The components in FIG. 5 are examples only and do not limit the scope of use or functionality of any hardware, software, embedded logic component, or a combination of two or more such components implementing particular embodiments.

Computer system 500 may include one or more processors 501, a memory 503, and a storage 508 that communicate with each other, and with other components, via a bus 540. The bus 540 may also link a display 532, one or more input devices 533 (which may, for example, include a keypad, a keyboard, a mouse, a stylus, etc.), one or more output devices 534, one or more storage devices 535, and various tangible storage media 536. All of these elements may interface directly or via one or more interfaces or adaptors to the bus 540. For instance, the various tangible storage media 536 can interface with the bus 540 via storage medium interface 526. Computer system 500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 500 includes one or more processor(s) 501 (e.g., central processing units (CPUs), general purpose graphics processing units (GPGPUs), or quantum processing units (QPUs)) that carry out functions. Processor(s) 501 optionally contains a cache memory unit 502 for temporary local storage of instructions, data, or computer addresses. Processor(s) 501 are configured to assist in execution of computer readable instructions. Computer system 500 may provide functionality for the components depicted in FIG. 5 as a result of the processor(s) 501 executing non-transitory, processor-executable instructions embodied in one or more tangible computer-readable storage media, such as memory 503, storage 508, storage devices 535, and/or storage medium 535. The computer-readable media may store software that implements particular embodiments, and processor(s) 501 may execute the software. Memory 503 may read the software from one or more other computer-readable media (such as mass storage device(s) 535, 536) or from one or more other sources through a suitable interface, such as network interface 520. The software may cause processor(s) 501 to carry out one or more processes or one or more steps of one or more processes described or illustrated herein. Carrying out such processes or steps may include defining data structures stored in memory 503 and modifying the data structures as directed by the software.

The memory 503 may include various components (e.g., machine readable media) including, but not limited to, a random access memory component (e.g., RAM 504) (e.g., static RAM (SRAM), dynamic RAM (DRAM), ferroelectric random access memory (FRAM), phase-change random access memory (PRAM), etc.), a read-only memory component (e.g., ROM 505), and any combinations thereof. ROM 505 may act to communicate data and instructions unidirectionally to processor(s) 501, and RAM 504 may act to communicate data and instructions bidirectionally with processor(s) 501. ROM 505 and RAM 504 may include any suitable tangible computer-readable media described below. In one example, a basic input/output system 506 (BIOS), including basic routines that help to transfer information between elements within computer system 500, such as during start-up, may be stored in the memory 503.

Fixed storage 508 is connected bidirectionally to processor(s) 501, optionally through storage control unit 507. Fixed storage 508 provides additional data storage capacity and may also include any suitable tangible computer-readable media described herein. Storage 508 may be used to store operating system 509, executable(s) 510, data 511, applications 512 (application programs), and the like. Storage 508 can also include an optical disk drive, a solid-state memory device (e.g., flash-based systems), or a combination of any of the above. Information in storage 508 may, in appropriate cases, be incorporated as virtual memory in memory 503.

In one example, storage device(s) 535 may be removably interfaced with computer system 500 (e.g., via an external port connector (not shown)) via a storage device interface 525. Particularly, storage device(s) 535 and an associated machine-readable medium may provide non-volatile and/or volatile storage of machine-readable instructions, data structures, program modules, and/or other data for the computer system 500. In one example, software may reside, completely or partially, within a machine-readable medium on storage device(s) 535. In another example, software may reside, completely or partially, within processor(s) 501.

Bus 540 connects a wide variety of subsystems. Herein, reference to a bus may encompass one or more digital signal lines serving a common function, where appropriate. Bus 540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 500 may also include an input device 533. In one example, a user of computer system 500 may enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 533 may be interfaced to bus 540 via any of a variety of input interfaces 523 (e.g., input interface 523) including, but not limited to, serial, parallel, game port, USB, FIREWIRE, THUNDERBOLT, or any combination of the above.

In particular embodiments, when computer system 500 is connected to network 530, computer system 500 may communicate with other devices, specifically mobile devices and enterprise systems, distributed computing systems, cloud storage systems, cloud computing systems, and the like, connected to network 530. Communications to and from computer system 500 may be sent through network interface 520. For example, network interface 520 may receive incoming communications (such as requests or responses from other devices) in the form of one or more packets (such as Internet Protocol (IP) packets) from network 530, and computer system 500 may store the incoming communications in memory 503 for processing. Computer system 500 may similarly store outgoing communications (such as requests or responses to other devices) in the form of one or more packets in memory 503 and communicated to network 530 from network interface 520. Processor(s) 501 may access these communication packets stored in memory 503 for processing.

Examples of the network interface 520 include, but are not limited to, a network interface card, a modem, and any combination thereof. Examples of a network 530 or network segment 530 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 530, may employ a wired and/or a wireless mode of communication. In general, any network topology may be used.

Information and data can be displayed through a display 532. Examples of a display 532 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 532 can interface to the processor(s) 501, memory 503, and fixed storage 508, as well as other devices, such as input device(s) 533, via the bus 540. The display 532 is linked to the bus 540 via a video interface 522, and transport of data between the display 532 and the bus 540 can be controlled via the graphics control 521. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 532, computer system 500 may include one or more other peripheral output devices 534 including, but not limited to, an audio speaker, a printer, a storage device, and any combinations thereof. Such peripheral output devices may be connected to the bus 540 via an output interface 524. Examples of an output interface 524 include, but are not limited to, a serial port, a parallel connection, a USB port, a FIREWIRE port, a THUNDERBOLT port, and any combinations thereof.

In addition or as an alternative, computer system 500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Sony® PS5®, Microsoft® Xbox 360®, Microsoft® Xbox One, Microsoft® Xbox Series X, Microsoft® Xbox Series S, Nintendo® Wii®, Nintendo® Wii U®, Nintendo® Switch™, and Ouya®.

Another aspect of the disclosure herein describes a non-transitory, computer-readable medium comprising executable instructions, wherein when a processor, when executing the executable instructions, performs a method as described herein.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5,Apple® QuickTime®, Microsoft® Silverlight®, Java™, and Unity®.

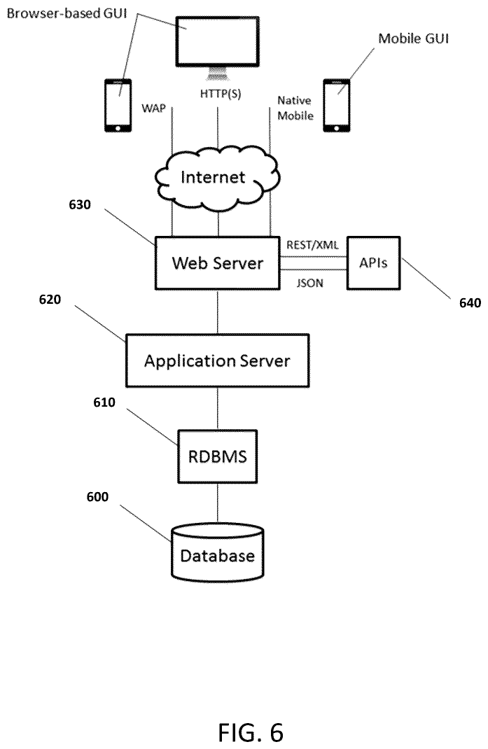

Referring to FIG. 6, in a particular embodiment, an application provision system comprises one or more databases 600 accessed by a relational database management system (RDBMS) 610. Suitable RDBMSs include Firebird, MySQL, PostgreSQL, SQLite, Oracle Database, Microsoft SQL Server, IBM DB2, IBM Informix, SAP Sybase, Teradata, and the like. In this embodiment, the application provision system further comprises one or more application severs 620 (such as Java servers,. NET servers, PHP servers, and the like) and one or more web servers 630 (such as Apache, IIS, GWS and the like). The web server(s) optionally expose one or more web services via app application programming interfaces (APIs) 640. Via a network, such as the Internet, the system provides browser-based and/or mobile native user interfaces.

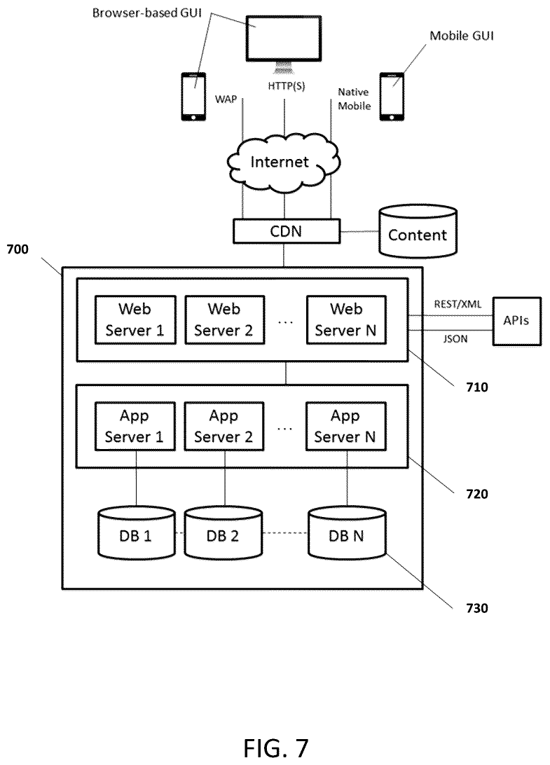

Referring to FIG. 7, in a particular embodiment, an application provision system alternatively has a distributed, cloud-based architecture 700 and comprises elastically load balanced, auto-scaling web server resources 710 and application server resources 720 as well synchronously replicated databases 730.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, Rails, VB.NET, WML, and XHTML/HTML with or without CSS, or combinations thereof.

Suitable mobile application development environments are available from several sources. Commercially available development environments include, by way of non-limiting examples, Airplay SDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code.

Suitable compiled programming languages include, by way of non-limiting examples, C, C++, Objective-C, COBOL, Delphi, Eiffel, Java™M, Lisp, Python™M, Visual Basic, and VB. NET, or combinations thereof. Compilation is often performed, at least in part, to create an executable program. In some embodiments, a computer program includes one or more executable complied applications.

### Web Browser Plug-in

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™ PHP, Python™, and VB.NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM Blackberry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of objects, metadata, or any combination thereof. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### Data Transmission

The subject matter described herein, including methods and systems as described herein and may be configured to be performed in one or more facilities at one or more locations.

Facility locations are not limited by country and include any country or territory. In some instances, one or more steps are performed in a different country than another step of the method. In some embodiments, one or more method steps involving a computer system are performed in a different country than another step of the methods provided herein. In some embodiments, data processing and storage are performed in a different country or location than one or more steps of the methods described herein. In some embodiments, one or more products or data are transferred from one or more of the facilities to one or more different facilities for analysis or further analysis. Data includes, but is not limited to, information regarding the stratification of a subject, and any data produced by the methods disclosed herein. In some embodiments of the methods and systems described herein, the subject information is compiled, and a subsequent data transmission step will transmit or store the subject information.

In some embodiments, any step of any method described herein is performed by a software program or module on a computer. In additional or further embodiments, data from any step of any method described herein is transferred to and from facilities located within the same or different countries, including analysis performed in one facility in a particular location and the data shipped to another location or directly to an individual in the same or a different country. In additional or further embodiments, data from any step of any method described herein is transferred to and/or received from a facility located within the same or different countries, including analysis of a data input, such as queries, objects, properties, types, filters, tables, or any combination thereof, performed in one facility in a particular location and corresponding data transmitted to another location.

### Business Methods Utilizing a Computer

The methods described herein may utilize one or more computers. The computer may be used for managing customer and subject information. The computer may include a monitor or other user interface for displaying data, results, billing information, marketing information (e.g. demographics), customer information, or sample information. The computer may also include means for data or information input. The computer may include a processing unit and fixed or removable media or a combination thereof. The computer may be accessed by a user in physical proximity to the computer, for example via a keyboard and/or mouse, or by a user that does not necessarily have access to the physical computer through a communication medium such as a modem, an internet connection, a telephone connection, or a wired or wireless communication signal carrier wave. In some cases, the computer may be connected to a server or other communication device for relaying information from a user to the computer or from the computer to a user. In some cases, the user may store data or information obtained from the computer through a communication medium on media, such as removable media. It is envisioned that data relating to the methods can be transmitted over such networks or connections for reception and/or review by a party.

The entity entering or reviewing information into a database for the purpose of one or more of the following: inventory tracking, order tracking, customer management, customer service, billing, and sales. Sample information may include, but is not limited to: customer name, unique customer identification, or any information suitable for storage in a database.

The database may be accessible by a user. Database access may take the form of electronic communication such as a computer or telephone. The database may be accessed through an intermediary such as a customer service representative, business representative, or consultant. The availability or degree of database access may change upon payment of a fee for products and services rendered or to be rendered.

### Definitions

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

### EXEMPLARY EMBODIMENTS

Described in the follow paragraphs are one or more exemplary embodiments of the systems and methods described herein:

Embodiment 1: A method for securely storing data on an object store, comprising: receiving a passphrase and an object at a computing device, wherein metadata is associated with the object; generating a first encryption key based on the passphrase; encrypting the metadata using a second encryption key; encrypting the object using a third encryption key; encrypting the third encryption key using the first encryption key; providing the encrypted object, the encrypted metadata, and the encrypted third encryption key to a processing device for storing in the object store.

Embodiment 2: The method of embodiment 1, wherein the first encryption key is a master key.

Embodiment 3: The method of embodiment 1 or 2, wherein one or more of the first encryption key, the second encryption key, or the third encryption key is a high entropy key.

Embodiment 4: The method of embodiment 2 or embodiment 3, wherein the master key is derived from the passphrase and a client-side generated key.

Embodiment 5: The method of any one of embodiments 1 to 4, further comprising generating the second encryption key.

Embodiment 6: The method of any one of embodiments 1 to 5, wherein one or more of the first encryption key, the second encryption key, or the third encryption key is a 256-bit secure random key.

Embodiment 7: The method of any one of embodiments 1 to 6, wherein the first encryption key and the second encryption key are generated using a passphrase based key derivation function2.

Embodiment 8: The method of any one of embodiments 1 to 7, wherein the metadata comprises an object identifier.

Embodiment 9: The method of any one of embodiments 1 to 8, wherein the metadata comprises a type of content of the object, a size of the object, a date of creation of the object, an entity associated with the object, or a name of the object.

Embodiment 10: The method of any one of embodiments 1 to 9, wherein the object store utilizes cloud computing.

Embodiment 11: The method of any one of embodiments 1 to 10, wherein receiving the passphrase and the object comprises receiving the passphrase and the object via user input.

Embodiment 12: The method of any one of embodiments 1 to 11, wherein storing the encrypted object, the encrypted metadata, and the encrypted third encryption key in the object store comprises providing the encrypted object, the encrypted metadata, and the encrypted third encryption key via a distributed stateless gateway service.

Embodiment 13: The method of any one of embodiments 1 to 12, wherein the metadata is stored on distributed solid-state drives.

Embodiment 14: The method of any one of embodiments 1 to 13, further comprising: storing the first encryption key and second encryption key on the computing device.

Embodiment 15: The method of any one of embodiments 1 to 14, wherein the computing device is configured to: decrypt the third encryption key using the first encryption key; and decrypt the object using the third encryption key.

Embodiment 16: The method of any one of embodiments 1 to 15, wherein the computing device is configured to: decrypt the metadata using the second encryption key.

Embodiment 17: The method of any one of embodiments 1 to 16, wherein a plurality of objects comprising the object are stored in one or more buckets in the object store.

Embodiment 18: The method of any one of embodiments 1 to 17, further comprising providing a request for one or more of the object and the metadata.

Embodiment 19: The method of embodiment 18, further comprising: receiving the encrypted object and the encrypted third encryption key in response to the request; decrypting the third encryption key using the first encryption key; and decrypting the object using the third encryption key.

Embodiment 20: The method of embodiment 18 or 19, further comprising: receiving the encrypted metadata in response to the request; and decrypting the metadata using the second encryption key.

Embodiment 21: A system, comprising: a memory; and one or more processors; wherein the at least one memory comprises computer-readable instructions which, when executed, cause the one or more processors to cause the system to: receive a passphrase and an object at a computing device, wherein metadata is associated with the object; generate a first encryption key based on the passphrase; encrypt the metadata using a second encryption key; encrypt the object using a third encryption key; encrypt the third encryption key using the first encryption key; provide the encrypted object, the encrypted metadata, and the encrypted third encryption key to a processing device for storing in the object store.

Embodiment 22: The system of embodiment 21, wherein the first encryption key is a master key.

Embodiment 23: The system of embodiment 21 or 22, wherein one or more of the first encryption key, the second encryption key, or the third encryption key is a high entropy key.

Embodiment 24: The system of embodiment 22 or embodiment 23, wherein the master key is derived from the passphrase and a client-side generated key.

Embodiment 25: The system of any one of embodiments 21 to 24, wherein the one or more processors are further configured to cause the system to generate the second encryption key.

Embodiment 26: The system of any one of embodiments 21 to 25, wherein one or more of the first encryption key, the second encryption key, or the third encryption key is a 256-bit secure random key.

Embodiment 27: The system of any one of embodiments 21 to 26, wherein the first encryption key and the second encryption key are generated using a passphrase based key derivation function2.

Embodiment 28: The system of any one of embodiments 21 to 27, wherein the metadata comprises an object identifier.

Embodiment 29: The system of any one of embodiments 21 to 28, wherein the metadata comprises a type of content of the object, a size of the object, a date of creation of the object, an entity associated with the object, or a name of the object.

Embodiment 30: The system of any one of embodiments 21 to 29, wherein the object store utilizes cloud computing.

Embodiment 31: The system of any one of embodiments 21 to 30, wherein the one or more processors being configured to cause the system to receive the passphrase and the object comprises the one or more processors being configured to cause the system to receive the passphrase and the object via user input.

Embodiment 32: The system of any one of embodiments 21 to 31, wherein the one or more processors being configured to cause the system to store the encrypted object, the encrypted metadata, and the encrypted third encryption key in the object store comprises the one or more processors being configured to cause the system to provide the encrypted object, the encrypted metadata, and the encrypted third encryption key via a distributed stateless gateway service.

Embodiment 33: The system of any one of embodiments 21 to 32, wherein the metadata is stored on distributed solid-state drives.

Embodiment 34: The system of any one of embodiments 21 to 33, wherein the one or more processors are further configured to cause the system to: store the first encryption key and second encryption key on the computing device.

Embodiment 35: The system of any one of embodiments 21 to 34, wherein the one or more processors are further configured to cause the system to decrypt the third encryption key using the first encryption key; and decrypt the object using the third encryption key.

Embodiment 36: The system of any one of embodiments 21 to 35, wherein the one or more processors are further configured to cause the system to:

decrypt the metadata using the second encryption key.

Embodiment 37: The system of any one of embodiments 21 to 36, wherein a plurality of objects comprising the object are stored in one or more buckets in the object store.

Embodiment 38: The system of any one of embodiments 21 to 37, wherein the one or more processors are further configured to cause the system to provide a request for one or more of the object and the metadata.

Embodiment 39: The system of embodiment 38, wherein the one or more processors are further configured to cause the system to: receive the encrypted object and the encrypted third encryption key in response to the request; decrypt the third encryption key using the first encryption key; and decrypt the object using the third encryption key.

Embodiment 40: The system of embodiment 38 or 39, wherein the one or more processors are further configured to cause the system to: receive the encrypted metadata in response to the request; and decrypt the metadata using the second encryption key.

Embodiment 41: A non-transitory, computer-readable medium comprising executable instructions, wherein when one or more processors, when executing the executable instructions, performs a method for securely storing data on an object store, the method comprising: receiving a passphrase and an object at a computing device, wherein metadata is associated with the object; generating a first encryption key based on the passphrase; encrypting the metadata using a second encryption key; encrypting the object using a third encryption key; encrypting the third encryption key using the first encryption key; providing the encrypted object, the encrypted metadata, and the encrypted third encryption key to a processing device for storing in the object store.

Embodiment 42: The computer-readable medium of embodiment 41, wherein the first encryption key is a master key.

Embodiment 43: The computer-readable medium of embodiment 41 or 42, wherein one or more of the first encryption key, the second encryption key, or the third encryption key is a high entropy key.

Embodiment 44: The computer-readable medium of embodiment 42 or embodiment 43, wherein the master key is derived from the passphrase and a client-side generated key.

Embodiment 45: The computer-readable medium of any one of embodiments 41 to 44, wherein the method further comprises generating the second encryption key.

Embodiment 46: The computer-readable medium of any one of embodiments 41 to 45, wherein one or more of the first encryption key, the second encryption key, or the third encryption key is a 256-bit secure random key.

Embodiment 47: The computer-readable medium of any one of embodiments 41 to 46, wherein the first encryption key and the second encryption key are generated using a passphrase based key derivation function2.

Embodiment 48: The computer-readable medium of any one of embodiments 41 to 47, wherein the metadata comprises an object identifier.

Embodiment 49: The computer-readable medium of any one of embodiments 41 to 48, wherein the metadata comprises a type of content of the object, a size of the object, a date of creation of the object, an entity associated with the object, or a name of the object.

Embodiment 50: The computer-readable medium of any one of embodiments 41 to 49, wherein the object store utilizes cloud computing.

Embodiment 51: The computer-readable medium of any one of embodiments 41 to 50, wherein receiving the passphrase and the object comprises receiving the passphrase and the object via user input.

Embodiment 52: The computer-readable medium of any one of embodiments 41 to 51, wherein storing the encrypted object, the encrypted metadata, and the encrypted third encryption key in the object store comprises providing the encrypted object, the encrypted metadata, and the encrypted third encryption key via a distributed stateless gateway service.

Embodiment 53: The computer-readable medium of any one of embodiments 41 to 52, wherein the metadata is stored on distributed solid-state drives.

Embodiment 54: The computer-readable medium of any one of embodiments 41 to 53, wherein the method further comprises: storing the first encryption key and second encryption key on the computing device.

Embodiment 55: The computer-readable medium of any one of embodiments 41 to 54, wherein the computing device is configured to: decrypt the third encryption key using the first encryption key; and decrypt the object using the third encryption key.

Embodiment 56: The computer-readable medium of any one of embodiments 41 to 55, wherein the computing device is configured to: decrypt the metadata using the second encryption key.

Embodiment 57: The computer-readable medium of any one of embodiments 41 to 56, wherein a plurality of objects comprising the object are stored in one or more buckets in the object store.

Embodiment 58: The computer-readable medium of any one of embodiments 41 to 57, wherein the method further comprises providing a request for one or more of the object and the metadata.

Embodiment 59: The computer-readable medium of embodiment 58, wherein the method further comprises: receiving the encrypted object and the encrypted third encryption key in response to the request; decrypting the third encryption key using the first encryption key; and decrypting the object using the third encryption key.

Embodiment 60: The computer-readable medium of embodiment 58 or 59, wherein the method further comprises: receiving the encrypted metadata in response to the request; and decrypting the metadata using the second encryption key.

Embodiment 61: A method for retrieving data from a storage device, comprising: providing a request for one or more of an object or metadata describing the object to a processing device; receiving one or more of an object, a first encryption key, or the metadata from the processing device, wherein: the received one or more of an object, the first encryption key or the metadata are encrypted, and the received one or more of the encrypted object and the encrypted metadata is retrieved by the processing device; and decrypting the one or more of an object, the first encryption key, or the metadata based on one or more other encryption keys.

Embodiment 62: The method of embodiment 61, wherein: the one or more of the object or the metadata comprises the object, and the one or more other encryption keys comprises a master key.

Embodiment 63: The method of embodiment 62, wherein the master key is a high entropy key.

Embodiment 64: The method of any one of embodiments 63, wherein decrypting the one or more of the object, the first encryption key, or the metadata based on the one or more other encryption keys comprises: decrypting the encrypted encryption key using one of the one or more other encryption keys, thereby creating a decrypted encryption key; and decrypting the object using the decrypted encryption key.

Embodiment 65: The method of any one of embodiments 62 to 64, wherein the master key is derived from the passphrase and a client-side generated key.

Embodiment 66: The method of any one of embodiments 61 to 65, wherein: the one or more of the object, the first encryption key, or the metadata comprises the metadata, and the one or more other encryption keys comprises an identification key.

Embodiment 67: The method of embodiment 66, further comprising encrypting one or more portions of the request using the identification key.

Embodiment 68: The method of any one of embodiments 61 to 67, wherein at least one of the one or more other encryption keys is generated using a passphrase based key derivation function2.

Embodiment 69: The method of any one of embodiments 61 to 68, wherein the one or more of the object, the first encryption key, or the metadata is retrieved from an object store.

Embodiment 70: The method of embodiment 69, wherein the object store utilizes cloud computing.

Embodiment 71: The method of any one of embodiments 61 to 70, wherein the metadata is stored on distributed solid-state drives.

Embodiment 72: The method of any one of embodiments 61 to 71, further comprising decrypting the metadata using the identification key.

Embodiment 73: The method of any one of embodiments 61 to 72, wherein a plurality of objects comprising the object are stored in one or more buckets in the object store.

Embodiment 74: A system, comprising: a memory; and one or more processors; wherein the at least one memory comprises computer-readable instructions which, when executed, cause the one or more processors to cause the system to: provide a request for one or more of an object or metadata describing the object to a processing device; receive the one or more of an object, a first encryption key, or the metadata from the processing device, wherein: the received one or more of an object, the first encryption key or the metadata are encrypted, and the received one or more of the encrypted object and the encrypted metadata is retrieved by the processing device; and decrypt the one or more of an object, the first encryption key, or the metadata based on one or more other encryption keys.

Embodiment 75: The system of embodiment 74, wherein: the one or more of the object or the metadata comprises the object, and the one or more other encryption keys comprises a master key.

Embodiment 76: The system of embodiment 75, wherein the master key is a high entropy key.

Embodiment 77: The system of embodiment any one of embodiments 74 to 76, wherein the one or more processors being configured to cause the system to decrypt the one or more of the object, the first encryption key, or the metadata based on the one or more other encryption keys comprises the one or more processors being configured to cause the system to: decrypt the encrypted encryption key using one of the one or more other encryption keys, thereby creating a decrypted encryption key; and decrypt the object using the decrypted encryption key.

Embodiment 78: The system of any one of embodiments 74 to 77, wherein the master key is derived from the passphrase and a client-side generated key.

Embodiment 79: The system of any one of embodiments 74 to 78, wherein: the one or more of the object, the first encryption key, or the metadata comprises the metadata, and the one or more other encryption keys comprises an identification key.

Embodiment 80: The system of embodiment 79, wherein the one or more processors are further configured to cause the system to encrypt one or more portions of the request using the identification key.

Embodiment 81: The system of any one of embodiments 74 to 80, wherein at least one of the one or more other encryption keys is generated using a passphrase based key derivation function2.

Embodiment 82: The system of any one of embodiments 74 to 81, wherein the one or more of the object, the first encryption key, or the metadata is retrieved from an object store.

Embodiment 83: The system of embodiment 82, wherein the object store utilizes cloud computing.

Embodiment 84: The system of any one of embodiments 74 to 83, wherein the metadata is stored on distributed solid-state drives.

Embodiment 85: The system of any one of embodiments 74 to 84, the one or more processors are further configured to cause the system to decrypt the metadata using the identification key.

Embodiment 86: The system of any one of embodiments 74 to 85, wherein a plurality of objects comprising the object are stored in one or more buckets in the object store.

Embodiment 87: A non-transitory, computer-readable medium comprising executable instructions, wherein when one or more processors, when executing the executable instructions, performs a method for retrieving data from a storage device, comprising: providing a request for one or more of an object or metadata describing the object to a processing device; receiving the one or more of an object, a first encryption key, or the metadata from the processing device, wherein: the received one or more of an object, the first encryption key or the metadata are encrypted, and the received one or more of the encrypted object and the encrypted metadata is retrieved by the processing device; and decrypting the one or more of an object, the first encryption key, or the metadata based on one or more other encryption keys.

Embodiment 88: The computer-readable medium of embodiment 87, wherein: the one or more of the object or the metadata comprises the object, and the one or more other encryption keys comprises a master key.

Embodiment 89: The computer-readable medium of embodiment 88, wherein the master key is a high entropy key.

Embodiment 90: The computer-readable medium of any one of embodiments 87 to 89, wherein decrypting the one or more of the object, the first encryption key, or the metadata based on the one or more other encryption keys comprises: decrypting the encrypted encryption key using one of the one or more other encryption keys, thereby creating a decrypted encryption key; and decrypting the object using the decrypted encryption key.

Embodiment 91: The computer-readable medium of any one of embodiments 88 to 90, wherein the master key is derived from the passphrase and a client-side generated key.

Embodiment 92: The computer-readable medium of any one of embodiments 87 to 91, wherein: the one or more of the object, the first encryption key, or the metadata comprises the metadata, and the one or more other encryption keys comprises an identification key.

Embodiment 93: The computer-readable medium of embodiment 92, wherein the computer-readable medium further comprises encrypting one or more portions of the request using the identification key.

Embodiment 94: The computer-readable medium of any one of embodiments 87 to 93, wherein at least one of the one or more other encryption keys is generated using a passphrase based key derivation function2.

Embodiment 95: The computer-readable medium of any one of embodiments 87 to 94, wherein the one or more of the object, the first encryption key, or the metadata is retrieved from an object store.

Embodiment 96: The computer-readable medium of embodiment 95, wherein the object store utilizes cloud computing.

Embodiment 97: The computer-readable medium of any one of embodiments 87 to 96, wherein the metadata is stored on distributed solid-state drives.

Embodiment 98: The computer-readable medium of any one of embodiments 87 to 97, further comprising decrypting the metadata using the identification key.

Embodiment 99: The computer-readable medium of any one of embodiments 87 to 98, wherein a plurality of objects comprising the object are stored in one or more buckets in the object store.

### EXAMPLES

The following examples are included for illustrative purposes only and are not intended to limit the scope of the inventive concepts.

### Example 1

### System for Secure Storage of Objects and Metadata

A computing device configured to communicate with a processing device is acquired.

The processing device is configured to store objects in an object store of the processing device. The computing device receives an object and metadata of the object. The computing device additionally receives a passphrase. The computing device generates a master key and an identification key based on the passphrase using PBKDF2. The computing device additionally generates a data key.

The computing device then encrypts the object using the data key. The computing device then encrypts the data key using the master key. The computing device also encrypts the metadata using the identification key.

The computing device then provides the encrypted object, the encrypted data key, and the encrypted metadata to the processing device, where the processing device then stores the encrypted object, the encrypted data key, and the encrypted metadata in the object store.

### Example 2

### System for Secure Storage of Objects and Metadata Using a Single Data Key

The system of Example 1 is obtained. A second object and metadata of the second object is received by the computing device. The computing device then encrypts the second object using the data key. The computing device then encrypts the data key using the master key. The computing device also encrypts the metadata of the second object using the identification key.

The computing device then provides the encrypted second object, the encrypted data key, and the encrypted metadata of the second object to the processing device, where the processing device then stores the encrypted second object, the encrypted data key, and the encrypted metadata of the second object in the object store.

### Example 3

### System for Secure Storage of Objects and Metadata Using Multiple Data Keys

The system of Example 1 is obtained. A second object and metadata of the second object is received by the computing device. The computing device then generates a second data key associated with the second object.

The computing device then encrypts the second object using the second data key. The computing device then encrypts the second data key using the master key. The computing device also encrypts the metadata of the second object using the identification key.

The computing device then provides the encrypted second object, the encrypted second data key, and the encrypted metadata of the second object to the processing device, where the processing device then stores the encrypted second object, the encrypted second data key, and the encrypted metadata of the second object in the object store.

### Example 4

### System for Retrieving Securely Stored Objects

The system of Example 1 is obtained. The computing device provides a request for the object stored in the object store to the processing device. The processing device identifies and retrieves the encrypted object and the encrypted data key based on the request. The processing device then provides the encrypted object and the encrypted data key to the computing device.

The computing device then uses the master key to decrypt the encrypted data key, and uses the decrypted data key to decrypt the object.

### Example 5

### System for Retrieving Securely Stored Metadata

The system of Example 1 is obtained. The computing device provides a request for the metadata of the object stored in the object store to the processing device. The processing device identifies and retrieves the encrypted metadata based on the request. The processing device then provides the encrypted metadata to the computing device. The computing device then uses the identification key to decrypt the encrypted metadata.

### Example 6

### System for Retrieving Securely Stored Objects and Metadata

The system of Example 1 is obtained. The computing device provides a request for the object and the metadata of the object stored in the object store to the processing device. The processing device identifies and retrieves the encrypted object, the encrypted data key, and the encrypted metadata based on the request. The processing device then provides the encrypted object, the encrypted data key, and the encrypted metadata to the computing device.

The computing device then uses the master key to decrypt the encrypted data key, and uses the decrypted data key to decrypt the object. The computing device also uses the identification key to decrypt the encrypted metadata.

While preferred embodiments of the present subject matter have been shown and described herein, it will be obvious to those skilled in the art that such embodiments are provided by way of example only. It is not intended that the subject matter described herein be limited by the specific examples provided within the specification. While the present subject matter has been described with reference to the aforementioned specification, the descriptions and illustrations of the embodiments herein are not meant to be construed in a limiting sense.

Numerous variations, changes, and substitutions will now occur to those skilled in the art without departing from the subject matter described herein. Furthermore, it shall be understood that all aspects of the present subject matter are not limited to the specific depictions, configurations or relative proportions set forth herein which depend upon a variety of conditions and variables. It should be understood that various alternatives to the embodiments of the subject matter described herein may be employed in practice. It is therefore contemplated that the present subject matter shall also cover any such alternatives, modifications, variations or equivalents. It is intended that the following claims define the scope of the present subject matter and that methods and structures within the scope of these claims and their equivalents be covered thereby.

What is claimed is:

1. A method for securely storing data on an object store, comprising:
a) receiving a passphrase and an object at a computing device, wherein metadata is associated with the object;
b) generating a first encryption key based on the passphrase;
c) encrypting the metadata using a second encryption key;
d) encrypting the object using a third encryption key;
e) encrypting the third encryption key using the first encryption key;
f) providing the encrypted object, the encrypted metadata, and the encrypted third encryption key to a processing device for storing in the object store.

2. The method of claim 1, wherein the first encryption key is a master key.

3. The method of claim 2, wherein the master key is derived from the passphrase and a client-side generated key.

4. The method of claim 1, further comprising generating the second encryption key.

5. The method of claim 1, wherein the metadata comprises:
a) an object identifier; or
b) a type of content of the object, a size of the object, a date of creation of the object, an entity associated with the object, or a name of the object.

6. The method of claim 1, further comprising:
a) storing the first encryption key and second encryption key on the computing device.

7. The method of claim 1, wherein the computing device is configured to:
a) decrypt the third encryption key using the first encryption key; and
b) decrypt the object using the third encryption key.

8. The method of claim 1, wherein the computing device is configured to:
a) decrypt the metadata using the second encryption key.

9. The method of claim 1, further comprising providing a request for one or more of the object and the metadata.

10. The method of claim 9, further comprising:
a) receiving the encrypted object and the encrypted third encryption key in response to the request;
b) decrypting the third encryption key using the first encryption key; and
c) decrypting the object using the third encryption key.

11. The method of claim 9, further comprising:
a) receiving the encrypted metadata in response to the request; and
b) decrypting the metadata using the second encryption key.

12. A system, comprising:
a memory; and
one or more processors;
wherein the memory comprises computer-readable instructions which, when executed, cause the one or more processors to cause the system to:
receive a passphrase and an object at a computing device, wherein metadata is associated with the object;
generate a first encryption key based on the passphrase;
encrypt the metadata using a second encryption key;
encrypt the object using a third encryption key;
encrypt the third encryption key using the first encryption key;
provide the encrypted object, the encrypted metadata, and the encrypted third encryption key to a processing device for storing in the object store.

13. The system of claim 12, wherein the first encryption key is a master key.

14. The system of claim 12, wherein the one or more processors are further configured to cause the system to generate the second encryption key.

15. The system of claim 12, wherein the one or more processors are further configured to cause the system to:
a) decrypt the third encryption key using the first encryption key; and
b) decrypt the object using the third encryption key.

16. The system of claim 12, wherein the one or more processors are further configured to cause the system to:
a) decrypt the metadata using the second encryption key.

17. The system of claim 12, wherein the one or more processors are further configured to cause the system to provide a request for one or more of the object and the metadata.

18. The system of claim 17, wherein the one or more processors are further configured to cause the system to:
a) receive the encrypted object and the encrypted third encryption key in response to the request;
b) decrypt the third encryption key using the first encryption key; and
c) decrypt the object using the third encryption key.

19. The system of claim 17, wherein the one or more processors are further configured to cause the system to:
a) receive the encrypted metadata in response to the request; and
b) decrypt the metadata using the second encryption key.

20. A non-transitory, computer-readable medium comprising executable instructions, wherein when one or more processors, when executing the executable instructions, performs a method for securely storing data on an object store, the method comprising:
a) receiving a passphrase and an object at a computing device, wherein metadata is associated with the object;
b) generating a first encryption key based on the passphrase;
c) encrypting the metadata using a second encryption key;
d) encrypting the object using a third encryption key;
e) encrypting the third encryption key using the first encryption key;
f) providing the encrypted object, the encrypted metadata, and the encrypted third encryption key to a processing device for storing in the object store.
